(19) United States
(12) Patent Application Publication
(10) Pub. No.: US 2012/0087708 A1
(43) Pub. Date: Apr. 12, 2012

(54) ELECTRICAL WIRE IDENTIFICATION MARKER

(76) Inventor: Sean Campbell, Columbus, OH (US)

(21) Appl. No.: 13/267,525

(22) Filed: Oct. 6, 2011

Related U.S. Application Data
(60) Provisional application No. 61/390,418, filed on Oct. 6, 2010.

(51) Int. Cl. B43K 5/00; B43K 1/00

(52) U.S. Cl. 401/11

(57) ABSTRACT

A marker for marking an electrical wire or conductor for identification comprises a shaft, a reservoir, and an applicator. The reservoir may comprise a first end and a second end. The first end of the applicator may be inserted to the reservoir. The reservoir may be capable of charging the applicator with marking liquid. The second end of the applicator may have a flat tip edge with an indentation to accommodate a wide range of different conductor sizes.

### RELATED APPLICATIONS

The present application claims benefit of U.S. Provisional Application No. 61/390418 filed on Oct. 6, 2010, the entirety of which is incorporated herein by reference.

### BACKGROUND OF THE INVENTION

The present invention generally relates to an electrical wire identification marker, and more specifically relates to an electrical wire identification marker that colors an electrical conductor to signify what they are being used for during interpretation of schematics of a wiring system.

### SUMMARY OF THE INVENTION

In one aspect of the present invention, a marker comprises a shaft; a reservoir inside the shaft; and an applicator having a first end and a second end, the first end inserted to the reservoir wherein the reservoir is disposed of charging the applicator device with marking liquid, and the second end having a flat tip edge with an indentation.

In another aspect of the present invention, a marker comprises a first housing having a reservoir inside the first housing; and a second housing having a first end and a second end, wherein the first end is adapted to connect to the first housing, the second end has a flat tip edge with an indentation.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention in use;

FIG. 2 is a perspective view of the exemplary embodiment of the present invention shown in FIG. 1 with an applicator arm cap placed on applicator arm;

FIG. 3 is a perspective view of the exemplary embodiment of the present invention shown in FIG. 1 with an applicator arm cap placed on applicator arm cap holder;

FIG. 4 a detailed perspective view of an exemplary embodiment of an application area of a felt applicator arm;

FIG. 5 is a projected view of an exemplary embodiment of the present invention taken along line 5-5 of FIG. 3;

FIG. 6 is a side view of the exemplary embodiment of the present invention as shown in FIG. 2;

FIG. 7 is an exploded perspective view of the exemplary embodiment of the present invention as shown in FIG. 2; and

FIG. 8 is a cross-sectional view of an exemplary embodiment of the present invention taken along line 8-8 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a marker for coloring electrical conductors to signify what they are used as for interpretation of schematics of a wiring system.

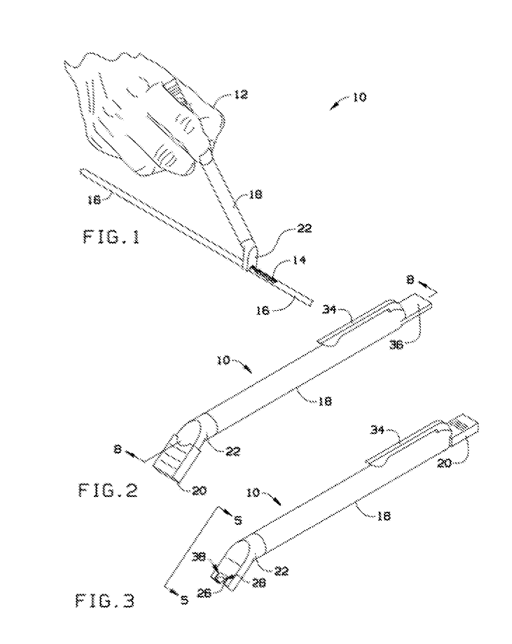

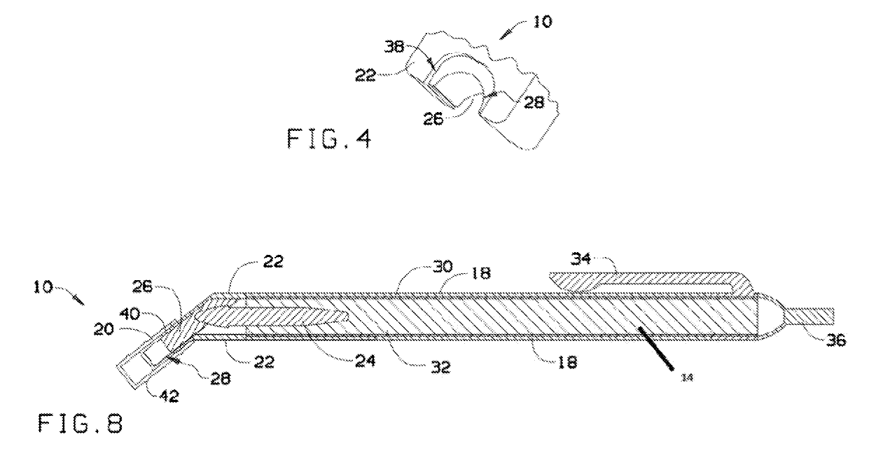

As shown in FIGS. 1-8, in an exemplary embodiment of the present invention, the marker 10 may be a pen configured and designed to allow quick and easy wire identification by coating or color-coding the conductor sheath with various ink colors and types of pens.

The marker 10 may comprise a housing 18 (also referred to as a reservoir chamber or a shaft,) and an applicator 12. The housing 18 may have a clip holder 34 and an applicator arm cap holder 36 at one end 44 of the housing 18. A felt reservoir 32 may be disposed inside the housing 18. The felt reservoir 32 may be designed to hold marking liquid, such as colored ink 14. The colored ink may be formulated to be dried quickly for fast use. There may be a plastic reservoir containment cover 30 outside of the felt reservoir 32. The plastic reservoir containment cover 30 may securely contain the felt reservoir 32 and colored ink 14 inside felt reservoir 32.

A communicator nib 24 may be housed within and between an applicator arm 22 of the applicator 12 and the housing 18. The applicator arm 22 may house a felt applicator nib 26 which communicates with the communicator nib 24. The communicator nib 24 may be configured to carry fluid, such as ink 14 from the felt reservoir 32 to the felt applicator nib 26.

The felt applicator nib 26 may include an indentation 60, such as, a semi-circular or half-moon shaped edge.

The applicator arm 22 may include flat tip edges 52 disposed at both sides of a housed application nib indentation 28. The flat tip edges 52 may also define the ends of a semi-circular shaped, open-faced edge indentation 38 disposed to expose the felt applicator nib 26. There may be a plurality of applicator arm cap snap teeth 40 which may be adapted to be snapped on by the ribs 42 of the applicator arm cap 20 .

In an exemplary embodiment of the present invention, the applicator arm 22 may have a bend 62 in an angle ranging from 0 to 90 degrees, typically from 22 to 60 degrees. The felt applicator nib 26 and the communicator nib 24 may be housed beyond the bend 62 inside the applicator arm 22 (see FIGS. 7 and 8).

The reservoir chamber 18, the applicator arm 22, and applicator arm cap 20 may comprise various polymer type materials that encase the felt applicator nib 26, the communicator nib 24, and felt reservoir 32 to provide air tightness and durable protection.

The communication nib 24 may extend out on one end 50 and slide into the felt reservoir 32 inside the marker to provide access and fluid communication of the colored ink 14 from the felt reservoir 32 to the second end 48 of the applicator arm 22 where the ink 14 may be applied to conductors and types of conductor sheath.

The felt applicator nib 26, the communicator nib 24, and the felt reservoir 32 may be made of porous compressed or non-compressed material such as felt, nylon, or polyester, wool, other similar material, to ensure proper fluidity of the colored ink 14 and durability of nib 26 for repetitive use and enough flexibility for good ink coverage on the uneven surface of the conductor sheath

The applicator arm cap 20 may be square on a first end and an indentation 64 on a second end with ribs 42 which are parallel to the first end providing facilitated gripping by hands. The applicator arm cap 20 may snap on and off from applicator arm 22. This may protect the exposed part of the felt applicator arm 22 from damage and being dried out.

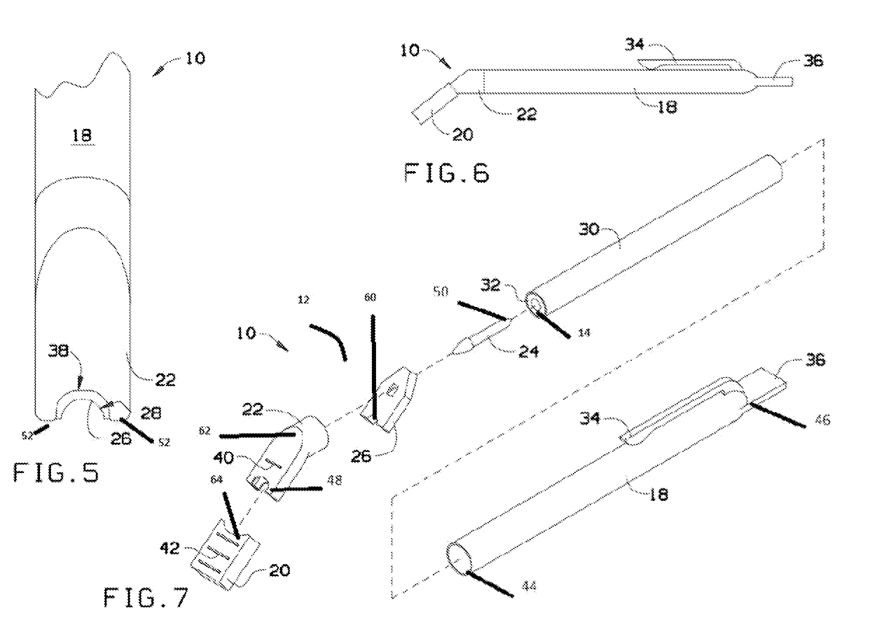

The applicator arm cap 20 may be snapped on to the reservoir chamber 18 which may form the applicator arm cap holder 36 when the marker 10 is in use as shown in FIG. 3.

In operation, the applicator arm 22 and reservoir chamber 18 may snap and may be sealed airtight together. In one exemplary use, the marker 10 may be laid firmly onto the surface of a conductor sheath so that the nib indentation 26 is exposed through the applicator arm 22 indentation 38 for indexed engagement of the applicator 12 to the surface of the underlying conductor sheath. The user may swab the sheath with the applicator 12 of the marker 10 until the conductor sheath has desired ink coverage and a desired length of wire colored.

In an exemplary embodiment, the colored ink 14 or paint may be made of various types of materials to give differing colors to each marker and to be considered permanent. rub and water resistant, which may include the use of ink and paint comprising materials, such as propanol, butanol, diacetone alcohol, cresol, or xylene, for example.

It should be understood, of course, that the foregoing relates to exemplary embodiments of the invention and that modifications may be made without departing from the spirit and scope of the invention as set forth in the following claims.

We claim:

1. A marker comprising:
a shaft,
a reservoir inside the shaft; and
an applicator having a first end and a second end, the first end inserted into the reservoir wherein the reservoir is disposed of charging the applicator with marking liquid, and the second end having a flat tip edge with an indentation.

2. The marker of claim 1, wherein the applicator comprises a communication nib located at the first end of the applicator device.

3. The marker of claim 1, further comprising an applicator arm, wherein the applicator arm is adapted to connect to the shaft.

4. The marker of claim 1, wherein the flat tip edge with an indentation has a semi-circle indentation.

5. The marker of claim 2, wherein the applicator has a felt application nib adapted to connect to the communication nib.

6. The marker of claim 1, further comprising an application arm cap adapted to cover the second end of the applicator arm.

7. A marker comprising:
a first housing having a reservoir inside the first housing; and
a second housing having a first end and a second end, wherein the first end is adapted to connect to the first housing, the second end has a flat tip edge with an semi-circle indentation.

8. The marker of claim 7, wherein the second end of the second housing forms an angle relative to the first end of the second housing.

9. The marker of claim 7, further comprises a felt applicator nib inside the second housing adapted to deliver marking liquid from the reservoir to the second end of second housing.

10. The marker of claim 7, further comprises a clip holder adapted to connect to the first housing.
